(19) United States
(12) Patent Application Publication
(10) Pub. No.: US 2023/0096492 A1
(43) Pub. Date: Mar. 30, 2023

(54) DISPLAY CONTROL DEVICE, DISPLAY CONTROL METHOD, AND NON-TRANSITORY COMPUTER-READABLE RECORDING MEDIUM

(71) Applicant: HONDA MOTOR CO., LTD., Tokyo (JP)

(72) Inventor: Eisaku Owada, Tokyo (JP)

(21) Appl. No.: 17/902,248

(22) Filed: Sep. 2, 2022

(30) Foreign Application Priority Data
Sep. 28, 2021 (JP) 2021-158419

(51) Int. Cl. B60Q 1/14; G09G 3/36; B60Q 9/00; B60Q 1/30

(52) U.S. Cl. CPC B60Q 1/1423; G09G 3/36; B60Q 9/00; B60Q 1/30; G09G 2380/10; B60Q 2300/21; B60Q 2300/33; B60Q 2300/31

(57) ABSTRACT

An in-vehicle device that displays a setting screen for setting a function of a vehicle includes a display control unit that displays a vehicle image which is an image of a vehicle having a plurality of light units on the setting screen and that changes the on-off state of each of the plurality of light units shown in the vehicle image, according to the function to be set of the vehicle.

### INCORPORATION BY REFERENCE

The present application claims priority under 35 U.S.C. § 119 to Japanese Patent Application No. 2021-158419 filed on Sep. 28, 2021. The content of the application is incorporated herein by reference in its entirety.

### BACKGROUND OF THE INVENTION

### Field of the Invention

The present invention relates to display control devices, display control methods, and non-transitory computer-readable recording mediums.

### Description of the Related Art

There have been known techniques for setting functions of vehicles.

For example, Japanese Patent Laid-Open No. 2005-297616 discloses a technique in which a customization menu is displayed on a display unit, and the functions that a control unit executes are set by operating operation switches.

### SUMMARY OF THE INVENTION

However, in Japanese Patent Laid-Open No. 2005-297616, the content of the customization menu is expressed by character strings, and hence regarding a function to be set of the vehicle, there is room for improvement in that the user can grasp the usage scene and the details of the function more easily.

The present invention has been made in light of the above situation, and an object thereof is to provide a configuration that allows the user, regarding a function to be set of a vehicle, to easily grasp the usage scene and the details of the function.

A display control device according to an aspect for achieving the above object is a display control device that displays a setting screen for setting a function of a vehicle, including a display control unit that displays a vehicle image which is an image of a vehicle having a plurality of light units on the setting screen and that changes the on-off state of each of the plurality of light units shown in the vehicle image, according to the function to be set of the vehicle.

For the above display control device, the configuration may be such that the display control unit changes the on-off state of each of the plurality of light units shown in the vehicle image, according to whether the function to be set of the vehicle is a function of the vehicle used in the nighttime or a function of the vehicle used in the daytime.

For the above display control device, the configuration may be such that the plurality of light units include a low-beam headlight and a tail light, and the display control unit, in a case in which the function to be set of the vehicle is a function of the vehicle used in the nighttime, turns on the low-beam headlight and the tail light shown in the vehicle image and, in a case in which the function to be set of the vehicle is a function of the vehicle used in the daytime, turns off the low-beam headlight and the tail light shown in the vehicle image.

For the above display control device, the configuration may be such that the display control unit changes the on-off state of each of the plurality of light units shown in the vehicle image, according to whether a wiper of the vehicle shown in the vehicle image is in operation.

For the above display control device, the configuration may be such that the plurality of light units include a low-beam headlight and a tail light, and the display control unit, in a case in which the wiper of the vehicle shown in the vehicle image is not in operation, turns off the low-beam headlight and the tail light shown in the vehicle image and, in a case in which the wiper of the vehicle shown in the vehicle image is in operation, turns on the low-beam headlight and the tail light shown in the vehicle image.

A display control method according to another aspect for achieving the above object is a display control method by using a display control device that displays a setting screen for setting a function of a vehicle, the display control method including: displaying a vehicle image which is an image of a vehicle having a plurality of light units on the setting screen; and changing the on-off state of each of the plurality of light units shown in the vehicle image, according to the function to be set of the vehicle.

A non-transitory computer-readable recording medium recording a program according to still another aspect for achieving the above object is for causing a processor of a display control device that displays a setting screen for setting a function of a vehicle to function as a display control unit that displays a vehicle image which is an image of a vehicle having a plurality of light units on the setting screen and that changes the on-off state of each of the plurality of light units shown in the vehicle image, according to the function to be set of the vehicle.

According to aspects of the present invention, it is possible to provide effects that allow the user, regarding a function to be set of a vehicle, to easily grasp the usage scene and the details of the function.

### BRIEF DESCRIPTION OF THE DRAWINGS

FIG. 1 is a diagram showing an example of a vehicle;

FIG. 2 is a diagram showing an example of the configuration of an in-vehicle device;

FIG. 3 is a diagram showing a table of basic patterns;

FIG. 4 is a diagram showing an example of a highest-level setting screen;

FIG. 5 is a diagram showing an example of a lower-level setting screen;

FIG. 6 is a diagram showing a table of variation patterns;

FIG. 7 is a diagram showing the on-off mode of the light units shown in a vehicle image;

FIG. 8 is a diagram showing the on-off mode of the light units shown in a vehicle image;

FIG. 9 is a diagram showing the on-off mode of the light units shown in a vehicle image;

FIG. 10 is a diagram showing the on-off mode of the light units shown in a vehicle image; and

FIG. 11 is a flowchart showing the operation of the in-vehicle device.

### DETAILED DESCRIPTION OF THE PREFERRED EMBODIMENTS

### 1. Configuration of Vehicle

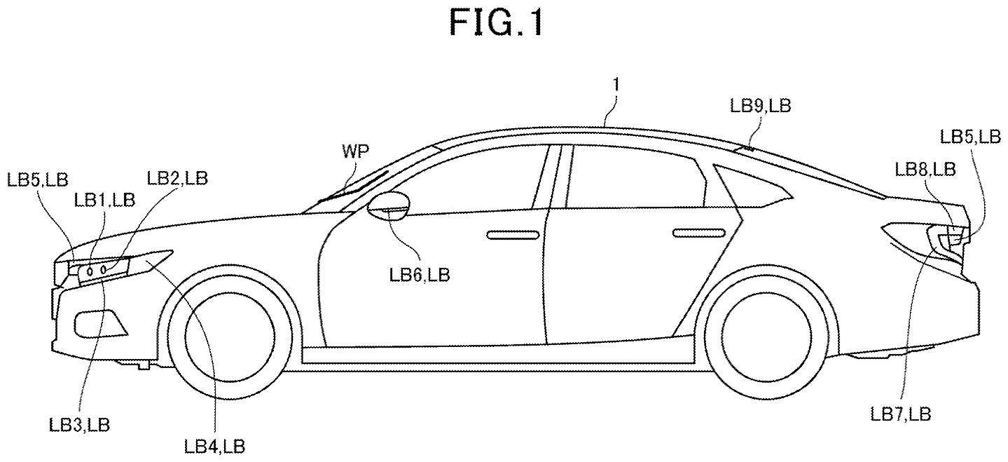

FIG. 1 is a diagram showing an example of a vehicle 1.

In the present embodiment, the vehicle 1 is a sedan four-wheeled vehicle as an example.

The vehicle 1 includes a plurality of light units LB. The vehicle 1 also includes wipers WP.

The plurality of light units LB in the present embodiment include high-beam headlights LB1, low-beam headlights LB2, daytime lights LB3, position lights LB4, turn signal lights LB5, side turn signal lights LB6, tail lights LB7, brake lights LB8, and a high mount brake light LB9.

The high-beam headlights LB1 are headlights having high beam output.

The low-beam headlights LB2 are headlights having low beam output.

The daytime lights LB3, which are also called the daytime running lights, are on in the daytime.

The position lights LB4 are side marker lights.

The turn signal lights LB5, which are provided at the front and rear of the vehicle body, indicate the moving direction of the vehicle 1.

The side turn signal lights LB6, which are provided on the mirror devices attached to doors, indicate the moving direction of the vehicle 1.

The tail lights LB7 are rear lights.

The brake lights LB8, which are lights different from the high mount brake light LB9, turn on when the brake pedal is depressed.

The high mount brake light LB9, which is provided at a rear upper portion of the vehicle body of the vehicle 1, turns on when the brake pedal is depressed.

The vehicle 1 includes an in-vehicle device 2. The in-vehicle device 2 includes a touch panel 3 provided in the vehicle 1, and the in-vehicle device 2 is, for example, a device called a display audio (DA) or a car navigation device.

The in-vehicle device 2 corresponds to an example of a “display control device”.

### 2. Configuration of In-Vehicle Device

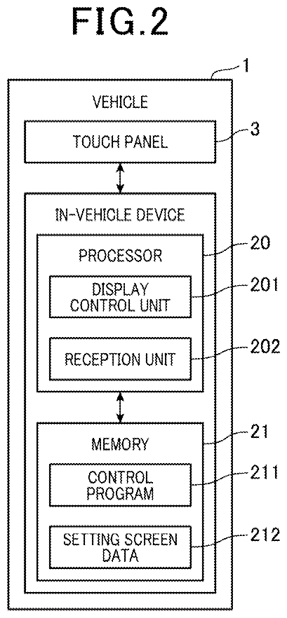

FIG. 2 is a diagram showing an example of the configuration of the in-vehicle device 2.

The in-vehicle device 2 includes a processor 20 such as a central processing unit (CPU) or a micro-processing unit (MPC) and memory 21 for storing programs and data.

The processor 20 functions as a display control unit 201 and a reception unit 202 by reading and executing a control program 211 stored in the memory 21.

The control program 211 corresponds to an example of a “program”.

The memory 21 stores programs that the processor 20 executes and data processed by the processor 20. The memory 21 stores the control program 211 executed by the processor 20, setting screen data 212, and other various kinds of data. The memory 21 has a nonvolatile storage area. The memory 21 may have a volatile storage area to provide a work area for the processor 20.

The setting screen data 212 is image data related to setting screens SG described later. The setting screen data 212 includes image data on various images such as an image of setting items KM related to setting of functions of the vehicle 1, a vehicle image VG representing the vehicle 1, an image of light for the case in which light units LB of the vehicle 1 shown in the vehicle image VG are turned on, and an image of the light units LB being on. The setting screen data 212 includes data on basic patterns described later and data on variation patterns described later.

As shown in FIG. 2, the in-vehicle device 2 is connected to the touch panel 3. Note that the devices that the in-vehicle device 2 is connected to are not limited to these devices, but the in-vehicle device 2 may be connected to other devices such as a global navigation satellite system (GNSS), a camera, and a telematics control unit (TCU), for example.

The touch panel 3 has a configuration having a liquid crystal display panel (display) that displays text and images and a touch sensor that is laid on the liquid crystal display panel and detects contact with the liquid crystal display panel. The touch panel 3 is, for example, disposed on the dashboard of the vehicle 1.

As described above, the processor 20 functions as the display control unit 201 and the reception unit 202.

The display control unit 201 displays the setting screens SG described later on the touch panel 3. The display control unit 201 changes the display content of the setting screen SG according to the user operation on the setting screen SG. Here, examples of the user include the occupants of the vehicle 1. The display control unit 201 refers to the setting screen data 212 stored in the memory 21 to generate setting screens SG and displays the generated setting screens SG on the touch panel 3. The display control unit 201 refers to the setting screen data 212 stored in the memory 21 to generate the display content of the setting screen SG and changes the display content of the setting screen SG from the display content being displayed to the generated display content.

The reception unit 202 receives operation by the user on the setting screen SG. The reception unit 202, having received an operation by the user on the setting screen SG, outputs information corresponding to the received operation to the display control unit 201.

### 3. Configuration of Setting Screen

Next, the setting screen SG will be described.

The setting screen SG is for setting functions of the vehicle 1. The setting screen SG has a configuration of a layered structure. The setting screen SG includes the vehicle image VG representing the vehicle 1. The vehicle image VG is a two-dimensional image of the vehicle 1. The vehicle 1 shown in the vehicle image VG is the same kind of vehicle 1 as the vehicle 1 having the in-vehicle device 2. Hence, in the case in which the vehicle 1 having the in-vehicle device 2 is the vehicle 1 in FIG. 1, the vehicle 1 shown in the vehicle image VG has the high-beam headlights LB1, the low-beam headlights LB2, the daytime lights LB3, the position lights LB4, the turn signal lights LB5, the side turn signal lights LB6, the tail lights LB7, the brake lights LB8, and the high mount brake light LB9. In the case in which the vehicle 1 having the in-vehicle device 2 is the vehicle 1 in FIG. 1, the vehicle 1 shown in the vehicle image VG has wipers WP.

Each of the plurality of light units LB shown in the vehicle image VG turns on and off according to basic patterns KP. The basic patterns KP are basic combinations of the on-off states of the plurality of light units LB in the setting screen SG regarding each of the plurality of light units LB.

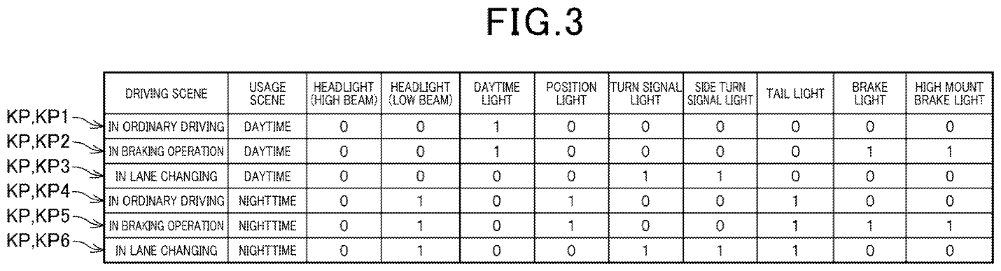

FIG. 3 is a diagram showing a table of the basic patterns KP.

FIG. 3 shows the combinations of the on-off states of the high-beam headlights LB1, the low-beam headlights LB2, the daytime lights LB3, the position lights LB4, the turn signal lights LB5, the side turn signal lights LB6, the tail lights LB7, the brake lights LB8, and the high mount brake light LB9. In FIG. 3, “1” indicates an on state, and “0” indicates an off state.

The present embodiment has six basic patterns KP: a first basic pattern KP1, a second basic pattern KP2, a third basic pattern KP3, a fourth basic pattern KP4, a fifth basic pattern KP5, and a sixth basic pattern KP6.

The first basic pattern KP1, the second basic pattern KP2, and the third basic pattern KP3 show combinations of on-off states on the assumption of daytime driving. In the on-off states according to the first basic pattern KP1, the second basic pattern KP2, and the third basic pattern KP3, the high-beam headlights LB1, the low-beam headlights LB2, the position lights LB4, and the tail lights LB7 are off in all of the first basic pattern KP1, the second basic pattern KP2, and the third basic pattern KP3. The on-off states according to the first basic pattern KP1 are on the assumption of the ordinary driving scene, in which the daytime lights LB3 are on. The on-off states according to the second basic pattern KP2 are on the assumption of the driving scene in braking operation, in which the daytime lights LB3, the brake lights LB8, and the high mount brake light LB9 are on. The on-off states according to the third basic pattern KP3 are on the assumption of the driving scene in lane changing, in which the turn signal lights LB5 and the side turn signal lights LB6 are on.

The fourth basic pattern KP4, the fifth basic pattern KP5, and the sixth basic pattern KP6 show combinations of on-off states on the assumption of nighttime driving. In the on-off states according to the fourth basic pattern KP4, the fifth basic pattern KP5, and the sixth basic pattern KP6, the low-beam headlights LB2 and the tail lights LB7 are on in all of the fourth basic pattern KP4, the fifth basic pattern KP5, and the sixth basic pattern KP6. The on-off states according to the fourth basic pattern KP4 are on the assumption of the ordinary driving scene, in which the position lights LB4 are on. The on-off states according to the fifth basic pattern KP5 are on the assumption of the driving scene in braking operation, in which the position lights LB4, the brake lights LB8, and the high mount brake light LB9 are on. The on-off states according to the sixth basic pattern KP6 are on the assumption of the driving scene in lane changing, in which the turn signal lights LB5 and the side turn signal lights LB6 are on.

Details of the setting screen SG will be described with reference to the drawings.

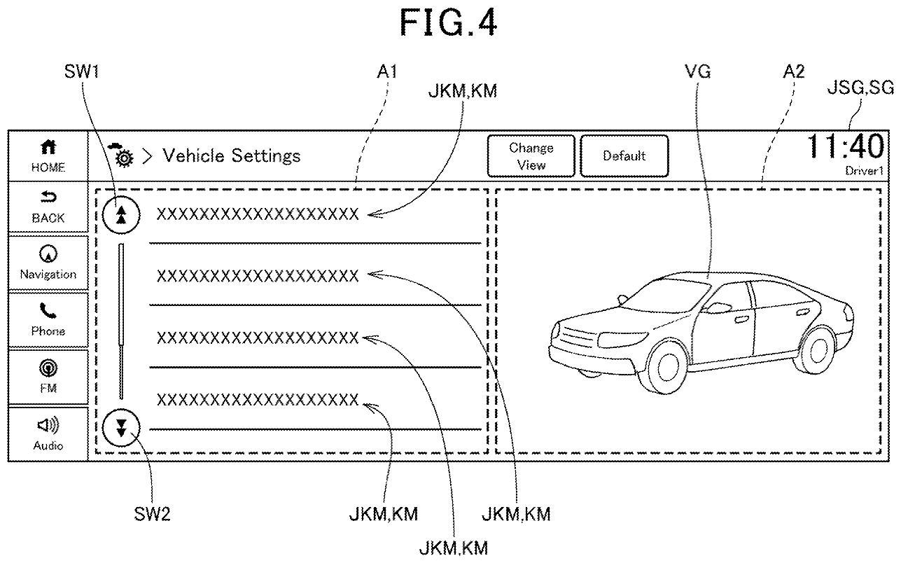

FIG. 4 is a diagram showing an example of a highest-level setting screen JSG.

The highest-level setting screen JSG is the setting screen SG at the highest level in the layered structure of the setting screen SG.

The highest-level setting screen JSG has an item list area A1 and an image display area A2.

The item list area A1 displays a plurality of setting items KM in list form. The setting items KM displayed in the item list area A1 are the items into which the types of functions of the vehicle 1 are classified in the highest level. In the following description, the setting items KM displayed on the highest-level setting screen JSG are referred to as “highest-level setting items” which are denoted by the symbol “JKM”. For example, the item list area A1 displays the highest-level setting item JKM corresponding to meter functions, the highest-level setting item JKM corresponding to keyless-entry functions, the highest-level setting item JKM corresponding to the functions of the light units LB, the highest-level setting item JKM corresponding to the door functions, the highest-level setting item JKM corresponding to the functions of the sonar included in the vehicle 1, and other information.

The item list area A1 has a first switch SW1 and a second switch SW2. The first switch SW1 and the second switch SW2 are software switches. The first switch SW1 and the second switch SW2 switch the highest-level setting items JKM displayed in the item list area A1.

The image display area A2 displays the vehicle image VG. Each of the plurality of light units LB shown in the vehicle image VG displayed in the image display area A2 is on or off, for example, according to the basic patterns KP in FIG. 3.

When one of the highest-level setting items JKM is selected in the item list area A1, the display control unit 201 displays a setting screen SG in the lower level than the highest-level setting screen JSG. In the following description, a setting screen SG in the lower level than the highest-level setting screen JSG is referred to as a “lower-level setting screen” which is denoted by the symbol “KSG”. When one of the highest-level setting items JKM is selected in the item list area A1, the display control unit 201 displays the lower-level setting screen KSG corresponding to the selected highest-level setting item JKM, on the touch panel 3.

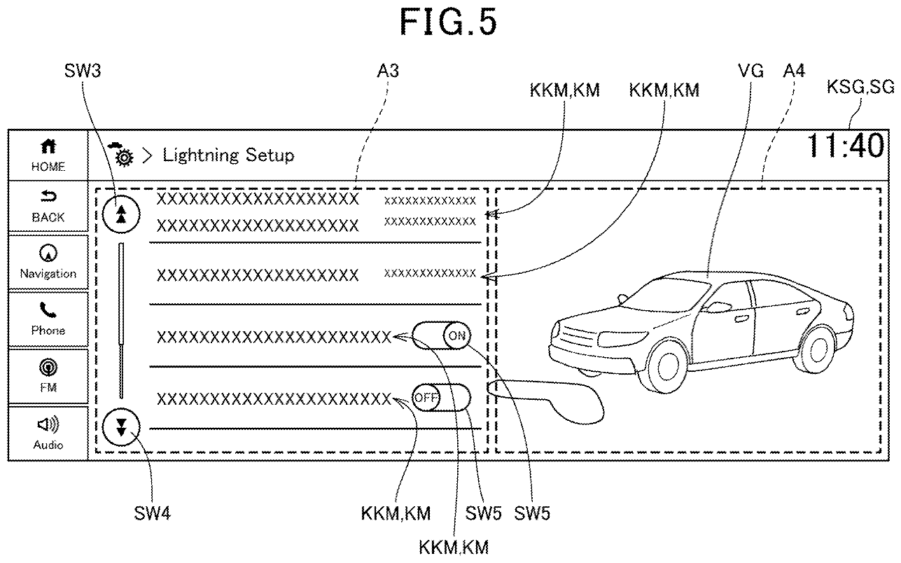

FIG. 5 is a diagram showing an example of a lower-level setting screen KSG. FIG. 5 shows, as an example, the lower-level setting screen KSG for setting the functions of the light units LB. Note that the lower-level setting screen KSG for setting the functions of the light units LB is displayed when the highest-level setting item JKM for setting the functions of the light units LB is selected in the item list area A1.

A lower-level setting screen KSG has an item list area A3 and an image display area A4.

The item list area A3 displays a plurality of setting items KM in list form. The setting items KM displayed in the item list area A3 are lower-level items into which the function of the vehicle 1 indicated by the highest-level setting item JKM selected in the highest-level setting screen JSG is divided. In the following description, the setting items KM displayed on the lower-level setting screen KSG are referred to as the “lower-level setting items”, which are denoted by the symbol “KKM”.

FIG. 5 shows the lower-level setting screen KSG for setting the functions of the light units LB as an example. Hence, the item list area A3 in FIG. 5 displays the lower-level setting items KKM for setting the functions of the light units LB in list form.

The item list area A3 has a third switch SW3 and a fourth switch SW4. The third switch SW3 and the fourth switch SW4 are software switches. The third switch SW3 and the fourth switch SW4 switch the lower-level setting items KKM displayed in the item list area A3.

The item list area A3 displays fifth switches SW5 at the lower-level setting items KKM the setting of which can be switched on and off. The item list area A3 displays the fifth switch SW5 for each lower-level setting item KKM the setting of which can be switched on and off such that the fifth switch SW5 is associated with the lower-level setting item KKM. The fifth switch SW5 is a software switch. The fifth switch SW5 receives, from the user, operation of turning on or off the setting of the function of the vehicle 1 indicated by the associated lower-level setting item KKM. The fifth switch SW5, when receiving an operation of turning on from the user, turns to an on state which means that switching-on has been received, and, when receiving an operation of turning off from the user, turns to an off state which means that switching-off has been received.

The image display area A4, as with the image display area A2, displays the vehicle image VG. When the state of a fifth switch SW5 is changed, the on-off mode of each of the plurality of light units LB shown in the vehicle image VG displayed in the image display area A4 changes from a basic pattern KP to a variation pattern HP.

The variation pattern HP is a combination of on-off states of the plurality of light units LB for the case in which the fifth switch SW5 is changed. Note that variation patterns HP for the case in which the vehicle image VG is displayed by animation include a combination of the light units LB that turn on and off at different times in a series of movements of the vehicle image VG.

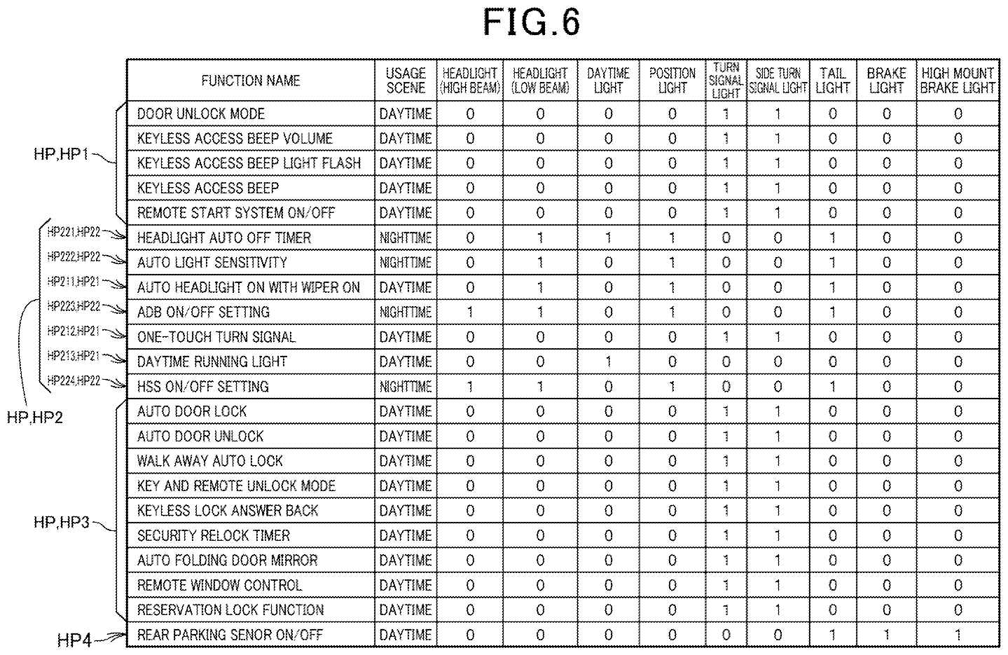

FIG. 6 is a diagram showing a table of variation patterns HP.

FIG. 6 shows combinations of on-off states of the high-beam headlights LB1, the low-beam headlights LB2, the daytime lights LB3, the position lights LB4, the turn signal lights LB5, the side turn signal lights LB6, the tail lights LB7, the brake lights LB8, and the high mount brake light LB9. In FIG. 6, “1” indicates an on state, and “0” indicates an off state.

The variation patterns HP of the present embodiment include variation patterns HP1 corresponding to the keyless-entry functions, variation patterns HP2 corresponding to the functions of the light units LB, variation patterns HP3 corresponding to the door functions, and a variation pattern HP4 corresponding to the sonar function. The variation patterns HP1, HP2, and HP3 show combinations of on-off states for the case in which the fifth switch SW5 is turned on. The variation pattern HP4 shows a combination of on-off states for the case in which the fifth switch SW5 is turned on or off.

The variation patterns HP1 show combinations of on-off states on the assumption that the keyless-entry function is used in the daytime, which are the same combinations as the third basic pattern KP3. The variation patterns HP3 show combinations of on-off states on the assumption that the door functions are used in the daytime, which are the same combinations as the third basic pattern KP3. The variation pattern HP4 shows a combination of on-off states on the assumption that the corresponding sonar function is used in the daytime.

The variation patterns HP2 include variation patterns HP21 and variation patterns HP22. The variation patterns HP21 show combinations of on-off states on the assumption that the corresponding functions of the light units LB are used in the daytime. The variation patterns HP22 show combinations of on-off states on the assumption that the corresponding functions of the light units LB are used in the nighttime.

In the on-off states according to the variation patterns HP21 except the variation pattern HP211 corresponding to the function name “Auto Headlight ON With Wiper ON”, the high-beam headlights LB1, the low-beam headlights LB2, the tail lights LB7, and the brake lights LB8 are off. In the on-off states according to the variation pattern HP212 corresponding to the function name “One-touch Turn Signal” out of the variation patterns HP21 except the variation pattern HP211, the daytime lights LB3 are off, and the turn signal lights LB5 and the side turn signal lights LB6 are on. In the on-off states according to the variation pattern HP213 corresponding to the function name “Daytime Running Light” out of the variation patterns HP21 except the variation pattern HP211, the daytime lights LB3 are on, the turn signal lights LB5 and the side turn signal lights LB6 are off.

In the on-off states according to the variation patterns HP22, the low-beam headlights LB2 and the tail lights LB7 are on. In the on-off states according to the variation pattern HP221 corresponding to the function name “Headlight Auto Off Timer” out of the variation patterns HP22, the high-beam headlights LB1, the turn signal lights LB5, the side turn signal lights LB6, and the brake lights LB8 are off, and the daytime lights LB3 and the position lights LB4 are on. In the on-off states according to the variation pattern HP222 corresponding to the function name “Auto Light Sensitivity” out of the variation patterns HP22, the high-beam headlights LB1, the daytime lights LB3, the turn signal lights LB5, the side turn signal lights LB6, and the brake lights LB8 are off, and the position lights LB4 are on. In the on-off states according to the variation pattern HP223 corresponding to the function name “ADB ON/OFF Setting” out of the variation patterns HP22, the daytime lights LB3, the turn signal lights LB5, the side turn signal lights LB6, and the brake lights LB8 are off, and the high-beam headlights LB1 and the position lights LB4 are on. In the on-off states according to the variation pattern HP224 corresponding to the function name “HSS ON/OFF Setting” out of the variation patterns HP22, the daytime lights LB3, the turn signal lights LB5, the side turn signal lights LB6, and the brake lights LB8 are off, and the high-beam headlights LB1 and the position lights LB4 are on.

Returning to the explanation of the lower-level setting screens KSG, when a fifth switch SW5 is turned on in a lower-level setting screen KSG, the display control unit 201 changes the on-off state of each of the plurality of light units LB shown in the vehicle image VG, according to the variation pattern corresponding to the function of the vehicle 1 indicated by the lower-level setting item KKM associated with this fifth switch SW5.

Here, the on-off states according to the variation patterns will be described by using a plurality of examples.

### 3-1. Example 1

Example 1 shows an example in which the setting of an automatic high beam function is turned on. The automatic high beam function automatically switches between high beams and low beams in nighttime driving.

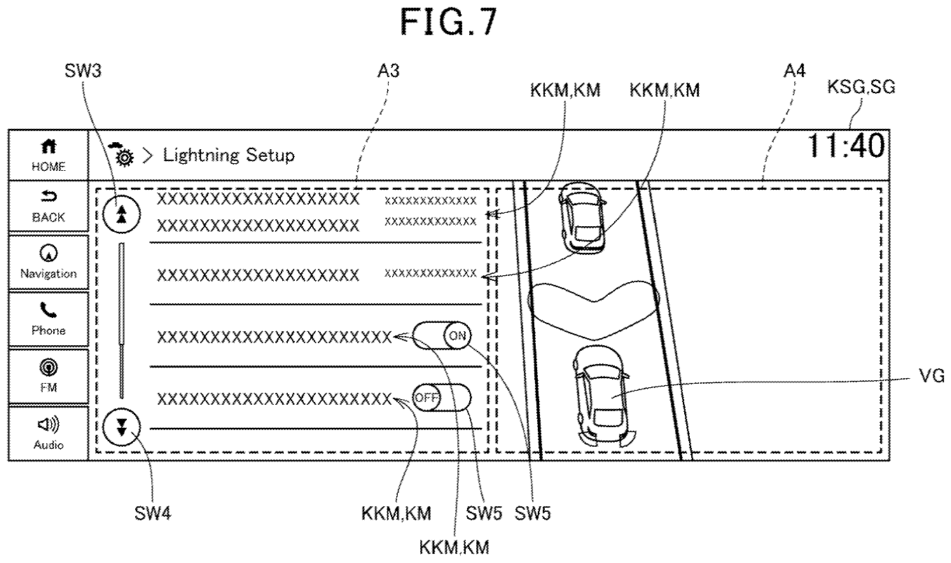

When a fifth switch SW5 is turned on in the item list area A3, and the setting of the automatic high beams is turned on, the image display area A4 displays the vehicle image VG shown in FIG. 7 according to the variation patterns HP in FIG. 6. Note that in the variation patterns HP in FIG. 6, the variation pattern HP corresponding to the automatic high beam function is the variation pattern HP224 corresponding to the function name “HSS ON/OFF Setting”.

FIG. 7 is a diagram showing the on-off mode of the light units LB shown in the vehicle image VG. FIG. 7 shows the vehicle image VG for the case in which the setting of the automatic high beam function is turned on. In other words, FIG. 7 shows the vehicle image VG for the case in which the fifth switch SW5 associated with the lower-level setting item KKM of the automatic high beam function is turned on.

When the setting of the automatic high beam function is turned on in the item list area A3, the image display area A4 displays the next vehicle image VG. Specifically, the image display area A4 displays the vehicle image VG indicating the vehicle 1 in which the high-beam headlights LB1, the low-beam headlights LB2, the position lights LB4, and the tail lights LB7 are on, and the daytime lights LB3, the turn signal lights LB5, the side turn signal lights LB6, and the brake lights LB8 are off.

### 3-2. Example 2

Example 2 shows an example in which the setting of an adaptive driving beam (ADB) function is turned on. The ADB function automatically adjusts the state of the high beams.

When a fifth switch SW5 is turned on in the item list area A3, and the setting of the ADB function is turned on, the image display area A4 displays the vehicle image VG in which the same light units LB as those of the vehicle image VG shown in FIG. 7 are on. Note that in the variation patterns HP in FIG. 6, the variation pattern HP corresponding to the ADB function is the variation pattern HP223 corresponding to the function name “ADB ON/OFF Setting”.

### 3-3. Example 3

Example 3 shows an example in which the setting of the wiper activated automatic turn-on function is turned on. The wiper activated automatic turn-on function automatically turns on the low-beam headlights LB2 when the wipers WP are operated.

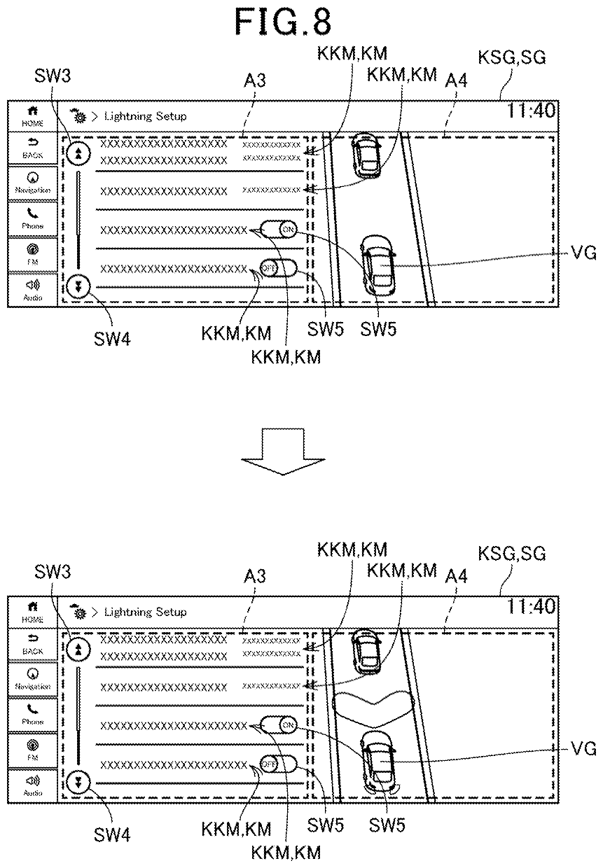

When a fifth switch SW5 is turned on in the item list area A3, and the setting of the wiper activated automatic turn-on function is turned on, the image display area A4 displays the vehicle image VG shown in FIG. 8 according to the variation patterns HP in FIG. 6. Note that in the variation patterns HP in FIG. 6, the variation pattern HP corresponding to the wiper activated automatic turn-on function is the variation pattern HP211 corresponding to the function name “Auto Headlight ON With Wiper ON”.

FIG. 8 is a diagram showing the on-off mode of the light units LB shown in the vehicle image VG. FIG. 8 shows the vehicle image VG for the case in which the setting of the wiper activated automatic turn-on function is turned on. In other words, FIG. 8 shows the vehicle image VG for the case in which the fifth switch SW5 associated with the lower-level setting item KKM of the wiper activated automatic turn-on function is turned on.

When the setting of the wiper activated automatic turn-on function is turned on, the image display area A4 first displays the vehicle image VG showing the vehicle 1 with the wipers WP not in operation and, after a specified time has passed, displays the vehicle image VG showing the vehicle 1 with the wipers WP in operation. The vehicle image VG of the vehicle 1 with the wipers WP not in operation shows the vehicle 1 with only the daytime lights LB3 on. The vehicle image VG of the vehicle 1 with the wipers WP in operation shows the vehicle 1 in which the low-beam headlights LB2, the position lights LB4, and the tail lights LB7 are on, and the high-beam headlights LB1, the daytime lights LB3, the turn signal lights LB5, the side turn signal lights LB6, and the brake lights LB8 are off.

### 3-4. Example 4

Example 4 shows an example in which the setting of a one-touch turn signal function is turned on. The one-touch turn signal function turns on and off the turn signal lights LB5 several times when the turn signal lever is pressed down or up and then returned to the original position.

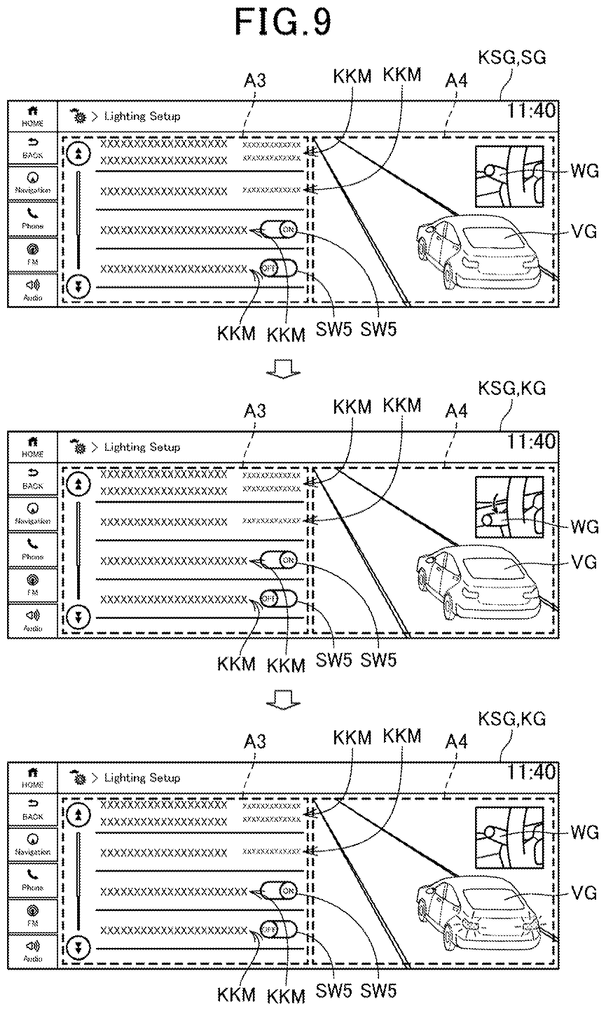

When a fifth switch SW5 is turned on in the item list area A3, and the setting of the one-touch turn signal function is turned on, the image display area A4 displays the vehicle image VG shown in FIG. 9 according to the variation patterns HP in FIG. 6. Note that in the variation patterns HP in FIG. 6, the variation pattern HP corresponding to the one-touch turn signal function is the variation pattern HP212 corresponding to the function name “One-Touch Turn Signal”.

FIG. 9 is a diagram showing the on-off mode of the light units LB shown in the vehicle image VG. FIG. 9 shows the vehicle image VG for the case in which the setting of the one-touch turn signal function is turned on. In other words, FIG. 9 shows the vehicle image VG for the case in which the fifth switch SW5 associated with the lower-level setting item KKM of the one-touch turn signal function is turned on.

As shown in FIG. 9, the image display area A4 corresponding to the one-touch turn signal function displays a turn signal lever image WG which shows the turn signal lever. When the setting of the one-touch turn signal function is turned on, the image display area A4 first displays the turn signal lever image WG showing the turn signal lever fully raised and the vehicle image VG with the light units LB on or off according to the basic patterns KP. Then, after a specified period has passed with this display, the image display area A4 displays the turn signal lever image WG showing the turn signal lever pressed down and the vehicle image VG with the light units LB on or off according to the basic patterns KP. After a specified period has passed with the display of the turn signal lever image WG pressed down, the image display area A4 displays the turn signal lever image WG showing the turn signal lever fully raised and the vehicle image VG with the turn signal light LB5 and the side turn signal lights LB6 on according to the variation pattern HP212.

The foregoing Example 1, Example 2, and Example 3 show cases in which the function to be set of the vehicle 1 is a function of the light units LB. The display control unit 201 changes the on-off states of the plurality of light units LB shown in the vehicle image VG according to the variation patterns HP also in terms of functions other than the functions of the light units LB.

For example, in the case in which the setting of the function of the function name “Keyless Access Beep Volume” is turned on out of the keyless-entry functions, the display control unit 201 changes the on-off state of each of the plurality of light units LB shown in the vehicle image VG displayed on the lower-level setting screen KSG to the on-off state according to the variation patterns HP1 in FIG. 6. Note that the lower-level setting items KKM of the function of the function name “Keyless Access Beep Volume” are displayed on the lower-level setting screen KSG on the setting of the keyless-entry function.

For example, in the case in which the setting of the function of the function name “Auto Door Lock” is turned on out of the door functions, the display control unit 201 changes the on-off state of each of the plurality of light units LB shown in the vehicle image VG displayed on the lower-level setting screen KSG to the on-off state according to the variation patterns HP3 in FIG. 6. Note that the lower-level setting items KKM of the function of the function name “Auto Door Lock” is displayed on the lower-level setting screen KSG on the setting of the door functions.

For example, in the case in which the setting of the function of the function name “Rear Parking Sensor ON/OFF”, which is a sonar function, is turned on, the display control unit 201 changes the on-off states of the plurality of light units LB shown in the vehicle image VG displayed on the lower-level setting screen KSG to the on-off states according to the variation pattern HP4 in FIG. 6. Note that the lower-level setting items KKM of the function of the function name “Rear Parking Sensor ON/OFF” are displayed on the lower-level setting screen KSG on the setting of the sonar function.

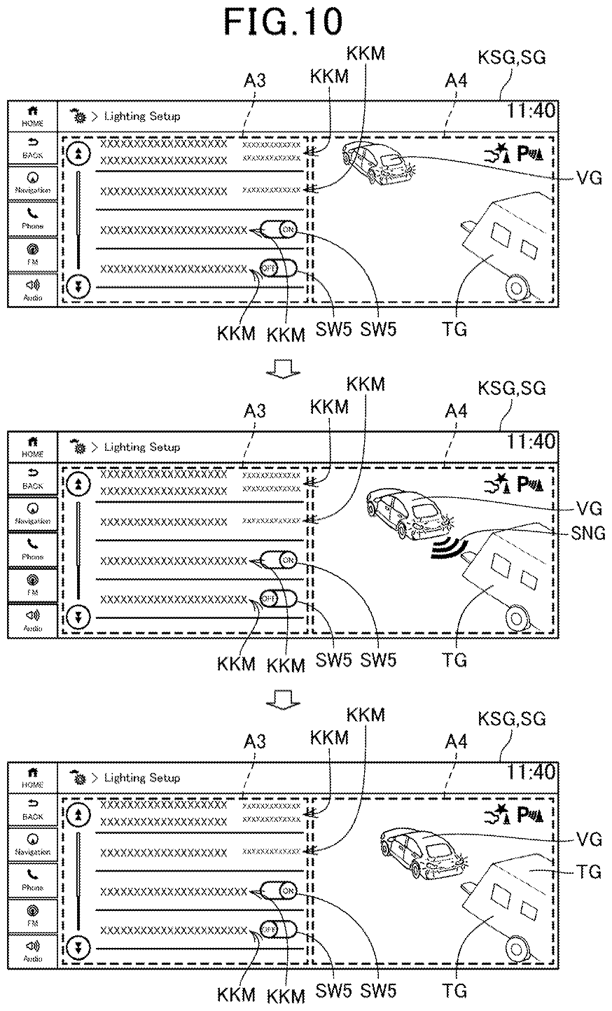

FIG. 10 is a diagram showing the on-off mode of the light units LB shown in the vehicle image VG. FIG. 10 shows the vehicle image VG for the case in which the setting of a rear-parking sonar on-off function is turned on. In other words, FIG. 10 shows the vehicle image VG for the case in which the fifth switch SW5 associated with the lower-level setting item KKM of the rear-parking sonar on-off function is turned on. Note that the rear-parking sonar on-off function turns on or off a sonar provided at a rear portion of the vehicle body of the vehicle 1 when the vehicle 1 reverses.

As shown in FIG. 10, the image display area A4 corresponding to the rear-parking sonar function displays a target object image TG which is an image of a target object located behind the vehicle 1, and the vehicle image VG. The vehicle image VG moves in the image display area A4 so as to come close to the target object image TG. When the setting of the rear-parking sonar function is turned on, the image display area A4 first displays the vehicle image VG with the tail lights LB7 on according to the variation pattern HP4. After this display, the image display area A4 displays the vehicle image VG moving closer to the target object image TG with the tail lights LB7 on. When the vehicle image VG is coming close to the target object image TG, the image display area A4 displays a sound wave image SNG representing sound waves between the vehicle image VG and the target object image TG. When the distance between the vehicle image VG and the target object image TG reaches a specified distance, the image display area A4 hides the sound wave image SNG and displays the stopped vehicle image VG. The stopped vehicle image VG shows the vehicle 1 with the brake lights LB8 on according to the variation pattern HP4.

Note that when the fifth switch SW5 associated with the lower-level setting item KKM of the rear-parking sonar on-off function is turned off, the image display area A4 does not display the sound wave image SNG and displays the vehicle image VG with its light units on or off as in FIG. 10 according to the variation pattern HP4.

As has been described above, the display control unit 201 changes the on-off state of each of the plurality of light units LB of the vehicle 1 shown in the vehicle image VG, according to the function to be set of the vehicle 1. This allows the user to grasp the on-off states of the light units LB, enabling the user to easily grasp the usage scenes and the details of the functions regarding the functions to be set of the vehicle 1. For example, by grasping the on-off states of the low-beam headlights LB2 and the tail lights LB7, the user can easily grasp whether the usage scene of the function to be set of the vehicle 1 is for the nighttime or the daytime. For example, by grasping the on-off states of the high-beam headlights LB1, the user can easily grasp that the function to be set of the vehicle 1 is a function involving turning on the high-beam headlights LB1.

### 4. Operation of In-Vehicle Device

Next, the operation of the in-vehicle device 2 related to displaying of the setting screen SG will be described.

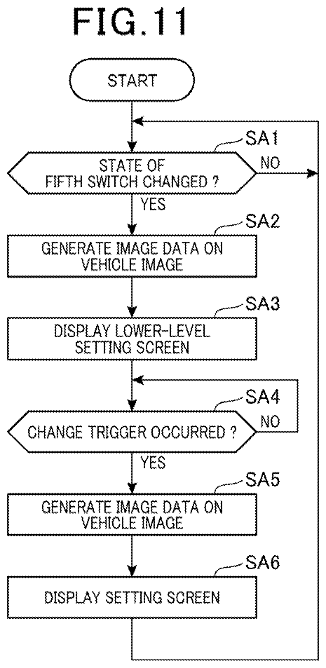

FIG. 11 is a flowchart showing the operation of the in-vehicle device 2.

The display control unit 201 of the in-vehicle device 2 determines based on the information inputted from the reception unit 202 whether the state of the fifth switch SW5 has been changed (step SA1).

If the display control unit 201 determines that the state of the fifth switch SW5 has not been changed (step SA1: NO), the display control unit 201 makes a determination at step SA1 again.

On the other hand, if the display control unit 201 determines that the state of the fifth switch SW5 has been changed (step SA1: YES), the display control unit 201 generates the image data on the vehicle image VG with the light units LB on or off according to the variation patterns HP in FIG. 6 (step SA2).

The display control unit 201 displays the lower-level setting screen KSG displaying the vehicle image VG expressed by the image data generated at step SA2, on the touch panel 3 (step SA3).

The display control unit 201 determines whether a change trigger has occurred (step SA4). Change triggers include triggers for displaying the vehicle image VG according to the basic patterns KP and triggers for displaying the vehicle image VG according to other variation patterns HP. Examples of triggers for displaying the vehicle image VG according to the basic patterns KP include, for example, as basic-pattern displaying triggers, a fifth switch SW5 being turned off, a screen transition from a lower-level setting screen KSG to the highest-level setting screen JSG, and a lower-level setting item KKM in the item list area A3 being switched to another. Examples of triggers for displaying the vehicle image VG according to other variation patterns HP include, for example, the case in which the fifth switch SW5 associated with the lower-level setting item KKM of the rear-parking sonar on-off function has been changed from an off state to an on state, and the case in which the fifth switch SW5 associated with the lower-level setting item KKM of the rear-parking sonar on-off function has been changed from an on state to an off state.

If the display control unit 201 determines that a change trigger has not occurred (step SA4: NO), the display control unit 201 makes a determination at step SA4 again.

If the display control unit 201 determines that a change trigger has occurred (step SA4: YES), the display control unit 201 generates image data on the vehicle image VG with the light units LB on or off according to the basic patterns KP or other variation patterns HP (step SA5).

Next, the display control unit 201 displays, on the touch panel 3, the setting screen SG displaying the vehicle image VG expressed by the image data generated at step SA5 (step SA6).

### 5. Other Embodiments

The foregoing embodiment has shown an example in which the vehicle 1 is a sedan four-wheeled vehicle. However, the vehicle 1 may be other four-wheeled vehicles such as wagon vehicles.

The foregoing embodiment has shown an example in which the vehicle 1 is a four-wheeled vehicle, but the vehicle 1 may be a vehicle other than four-wheeled vehicles. In this case, the setting screen SG displays a vehicle image VG of a vehicle 1 other than four-wheeled ones.

The foregoing embodiment has shown an example in which the “display control device” is the in-vehicle device 2, but the “display control device” may be, for example, a mobile terminal such as a smartphone.

In the foregoing embodiment, the vehicle 1 has a configuration including eight kinds of light units LB: the high-beam headlights LB1, the low-beam headlights LB2, the daytime lights LB3, the position lights LB4, the turn signal lights LB5, the side turn signal lights LB6, the tail lights LB7, and the brake lights LB8. However, the number of kinds of light unit LB included in the vehicle 1 is not limited to the above eight kinds, but the number of kinds may be more or may be less.

The processor 20 may include a plurality of processors or may be a single processor. The processor 20 may be hardware programed to have the corresponding functional units. In other words, the processor 20 may be formed of, for example, an application specific integrated circuit (ASIC), a field programmable gate array (FPGA), or the like.

The configurations of the vehicle 1 and the in-vehicle device 2 shown in FIG. 2 are examples, and hence specific configurations are not limited to those examples. In other words, each unit does not necessarily have to have a corresponding individual piece of hardware, and the configuration may be such that one processor executes a program to implement the function of each unit, as a matter of course. In the foregoing embodiment, part of the functions implemented by software may be implemented by hardware, or part of the functions implemented by hardware may be implemented by software. In addition, specific detailed configurations of units other than the vehicle 1 and the in-vehicle device 2 may also be changed as appropriate within the range not departing from the spirit of the present disclosure.

The step units of the operation shown in FIG. 11 are ones obtained by dividing the entire process according to main process details to make it easy to understand the operation, and the way of division into the process units and the names of the process units do not limit the operation. The entire process may be divided into more smaller step units according to the process details. Alternatively, the entire process may be divided such that one step unit has more processes. The order of the steps may be changed as appropriate as far as the change does not hinder the spirit of the present disclosure.

The control program 211 to be executed by the processor 20 may be implemented in a state of being recorded in a portable information recording medium. Examples of information recording media include a magnetic recording medium such as a hard disk, an optical recording medium such as a CD, and a semiconductor storage device such as a Universal Serial Bus (USB) memory and a solid state drive (SSD), but other types of recording medium may be used.

### 6. Configurations Supported by Above Embodiments

The above embodiments support the following configurations.

(Configuration 1) A display control device that displays a setting screen for setting a function of a vehicle, including a display control unit that displays a vehicle image which is an image of a vehicle having a plurality of light units on the setting screen and that changes the on-off state of each of the plurality of light units shown in the vehicle image, according to the function to be set of the vehicle.

Since the display control device according to Configuration 1 changes the on-off state of each of the plurality of light units shown in the vehicle image, according to the function to be set of the vehicle, the user can easily grasp, regarding a function to be set of the vehicle, the usage scene and the details of the function.

(Configuration 2) The display control device according to Configuration 1, in which the display control unit changes the on-off state of each of the plurality of light units shown in the vehicle image, according to whether the function to be set of the vehicle is a function of the vehicle used in the nighttime or a function of the vehicle used in the daytime.

Since the display control device according to Configuration 2 changes the on-off state of each of the plurality of light units shown in the vehicle image according to whether the function to be set of the vehicle is a function of the vehicle used in the nighttime or a function of the vehicle used in the daytime, the user can easily grasp whether the usage scene of the function to be set of the vehicle is in the nighttime or in the daytime.

(Configuration 3) The display control device according to Configuration 2, in which the plurality of light units include a low-beam headlight and a tail light, and the display control unit, in a case in which the function to be set of the vehicle is a function of the vehicle used in the nighttime, turns on the low-beam headlight and the tail light shown in the vehicle image and, in a case in which the function to be set of the vehicle is a function of the vehicle used in the daytime, turns off the low-beam headlight and the tail light shown in the vehicle image.

With the display control device according to Configuration 3, by grasping whether the low-beam headlight and the tail light are on or off, the user can easily grasp whether the usage scene of the function to be set of the vehicle is in the nighttime or in the daytime.

(Configuration 4) The display control device according to any one of Configurations 1 to 3, in which the display control unit changes the on-off state of each of the plurality of light units shown in the vehicle image, according to whether a wiper of the vehicle shown in the vehicle image is in operation.

Since the display control device according to Configuration 4 changes the on-off state of each of the plurality of light units according to whether the wiper is in operation, the user can easily grasp the usage scene and details of the function related to the wiper.

(Configuration 5) The display control device according to Configuration 4, in which the plurality of light units include a low-beam headlight and a tail light, and the display control unit, in a case in which the wiper of the vehicle shown in the vehicle image is not in operation, turns off the low-beam headlight and the tail light shown in the vehicle image and, in a case in which the wiper of the vehicle shown in the vehicle image is in operation, turns on the low-beam headlight and the tail light shown in the vehicle image.

Since the display control device according to Configuration 5 changes the on-off states of the low-beam headlight and the tail light according to whether the wiper is in operation, the user can more easily grasp the usage scene and details of the function related to the wiper.

(Configuration 6) A display control method by using a display control device that displays a setting screen for setting a function of a vehicle, the display control method including: displaying a vehicle image which is an image of a vehicle having a plurality of light units on the setting screen; and changing the on-off state of each of the plurality of light units shown in the vehicle image, according to the function to be set of the vehicle.

The display control method according to Configuration 6 provides effects the same as or similar to those of the display control device according to Configuration 1.

(Configuration 7) A non-transitory computer-readable recording medium recording a program for causing a processor of a display control device that displays a setting screen for setting a function of a vehicle to function as a display control unit that displays a vehicle image which is an image of a vehicle having a plurality of light units on the setting screen and that changes the on-off state of each of the plurality of light units shown in the vehicle image, according to the function to be set of the vehicle.

The program according to Configuration 7 provides effects the same as or similar to those of the display control device according to Configuration 1.

### REFERENCE SIGNS LIST

1 vehicle
2 in-vehicle device
3 touch panel
20 processor
21 memory
201 display control unit
202 reception unit
211 control program (program)
212 setting screen data
LB light unit
LB1 high-beam headlight (light unit)
LB2 low-beam headlight (light unit)
LB3 daytime light (light unit)
LB4 position light (light unit)
LB5 turn signal light (light unit)
LB6 side turn signal light (light unit)
LB7 tail light (light unit)
LB8 brake light (light unit)
LB9 high mount brake light (light unit)
SG setting screen
VG vehicle image
WP wiper

What is claimed is:

1. A display control device that displays a setting screen for setting a function of a vehicle, comprising
a display control unit that displays a vehicle image which is an image of a vehicle having a plurality of light units on the setting screen and that changes the on-off state of each of the plurality of light units shown in the vehicle image, according to the function to be set of the vehicle.

2. The display control device according to claim 1, wherein
the display control unit
changes the on-off state of each of the plurality of light units shown in the vehicle image, according to whether the function to be set of the vehicle is a function of the vehicle used in the nighttime or a function of the vehicle used in the daytime.

3. The display control device according to claim 2, wherein
the plurality of light units include a low-beam headlight and a tail light, and
the display control unit,
in a case in which the function to be set of the vehicle is a function of the vehicle used in the nighttime, turns on the low-beam headlight and the tail light shown in the vehicle image and,
in a case in which the function to be set of the vehicle is a function of the vehicle used in the daytime, turns off the low-beam headlight and the tail light shown in the vehicle image.

4. The display control device according to claim 1, wherein
the display control unit
changes the on-off state of each of the plurality of light units shown in the vehicle image, according to whether a wiper of the vehicle shown in the vehicle image is in operation.

5. The display control device according to claim 4, wherein
the plurality of light units include a low-beam headlight and a tail light, and
the display control unit,
in a case in which the wiper of the vehicle shown in the vehicle image is not in operation, turns off the low-beam headlight and the tail light shown in the vehicle image and,
in a case in which the wiper of the vehicle shown in the vehicle image is in operation, turns on the low-beam headlight and the tail light shown in the vehicle image.

6. A display control method by using a display control device that displays a setting screen for setting a function of a vehicle, the display control method comprising:
displaying a vehicle image which is an image of a vehicle having a plurality of light units on the setting screen; and
changing the on-off state of each of the plurality of light units shown in the vehicle image, according to the function to be set of the vehicle.

7. A non-transitory computer-readable recording medium recording a program for causing a processor of a display control device that displays a setting screen for setting a function of a vehicle to function as
a display control unit that displays a vehicle image which is an image of a vehicle having a plurality of light units on the setting screen and that changes the on-off state of each of the plurality of light units shown in the vehicle image, according to the function to be set of the vehicle.
